(19) United States
(12) Patent Application Publication
(10) Pub. No.: US 2017/0352460 A1
(43) Pub. Date: Dec. 7, 2017

(54) MAGNETIC FIELD GENERATION APPARATUS OF MAGNETORHEOLOGICAL POLISHING DEVICE

(71) Applicant: Yuhuan CNC Machine Tool Co., LTD, Hunan (CN)

(72) Inventors: Liang Xu, Hunan (CN); Yongfu Chen, Hunan (CN); Jun Xu, Hunan (CN); Zhi Li, Hunan (CN); Feng Wei, Hunan (CN)

(21) Appl. No.: 15/536,282

(22) PCT Filed: Oct. 17, 2016
(86) PCT No.: PCT/CN2016/102291

§ 371 Date: Jun. 15, 2017

(30) Foreign Application Priority Data
Aug. 17, 2015 (CN) 201510502796.5
Aug. 17, 2015 (CN) 201520620689.8

(51) Int. Cl. H01F 7/02; B24B 1/00; B24B 37/10; H01F 7/16

(52) U.S. Cl. CPC H01F 7/0278; B24B 37/105; B24B 1/005; H01F 2007/1692

(57) ABSTRACT

A magnetic field generation apparatus (6) of a magnetorheological polishing device comprises at least one electromagnetic pole set capable of producing a gradient magnetic field and consisting of two electromagnetic poles having opposing polarities; the electromagnetic poles forming the electromagnetic pole set uses at least two annular magnetic poles arranged in concentric circles, wherein the polarities of two adjacent magnetic poles are opposing. The apparatus (6) is used for processing a multi-degree of freedom movement workpiece with a magnetorheological fluid, and with single clamping, is capable of simultaneously performing polishing processing on the outer surface(s) of one or more workpieces, the outer surfaces of which may be flat surfaces, cambered surfaces or complex curved surfaces. The apparatus (6) effectively solves the problem of it being difficult to finish complex shaped surfaces, reduces workpiece processing procedures, and effectively increases polishing efficiency.

### TECHNICAL FIELD

The invention belongs to a magneto rheological polishing device and in particular to a magnetic field generation apparatus of a magnetorheological polishing device.

### BACKGROUND

As the modern information electronic technologies and optical technologies are improved constantly, super-smooth elements, such as sapphire monocrystalline silicon surfaces and rear covers of mobile phones, have been applied more and more to the IT and electronic industries, and these components are processed in a large scale and have the surfaces that need to meet the requirements on super smoothness, high gloss, uniform color, no scratch. At present, grinding and polishing machines on the market are based on the principle of flat-surface mutual grinding, where a workpiece is clamped in a center shifting wheel and is finished under the grinding action of upper and lower polishing plates. Such polishing manner has the limitation that only flat surfaces can be processed but curved surfaces cannot be processed.

A magnetorheological fluid is an intelligent material, which is a suspension formed by mixing soft magnetic microparticles having high magnetic permeability and low magnetic hysteresis, and a non-magnetoconductive liquid. It is a liquid under a normal state, and undergoes liquid-solid phase transformation when a magnetic field is loaded and solid-liquid phase transformation when the magnetic field is removed. Within the range of certain magnetic field intensity, the apparent viscosity of the magnetorheological fluid is related to the magnetic field intensity, and this phenomenon is called as a magnetorheological effect. By using the magnetorheological effect of the magnetorheological fluid, grinding particles can be gathered at a polishing area to form a flexible grinding head, which has the advantages of adjustable hardness, self-sharpening of the grinding particles, good surface mating property and the like and exhibits an excellent performance for polishing.

For an existing magnetorheological polishing device, the hardness of the grinding head can be changed by changing the magnetic field intensity during the polishing work. However, due to the structural limitation of the magnetic field generation apparatus, the effective polishing area of a magnetic field is small, the material removing model of the whole polishing area is fixed, and thus, the polishing of a complex curved surface is impossible.

### SUMMARY OF THE INVENTION

An object of the invention is to provide a magnetic field generation apparatus of a magnetorheological polishing device, which provides a uniformly distributed magnetic field and a large effective polishing area of a magnetic field and is applicable to a multi-degree of freedom movement workpiece.

The magnetic field generation apparatus of the magnetorheological polishing device provided by the invention comprises at least one electromagnetic pole set capable of producing a gradient magnetic field and consisting of two electromagnetic poles having opposing polarities; the electromagnetic poles forming the electromagnetic pole set use at least two annular magnetic poles arranged in concentric circles, wherein the polarities of two adjacent magnetic poles are opposing.

Each annular magnetic pole comprises an annular magnetic core and a magnetic core coil wound on the outer surface of the annular magnetic core, with the annular magnetic core and the magnetic core coil fixed on a base plate.

The magnetic field generation apparatus is arranged below a cylindrical polishing fluid tank; an outer coil is arranged on the outer periphery of the polishing fluid tank; and a lower plane of the outer coil is flush with upper planes of the annular magnetic poles.

The invention has the following advantageous effects.

The magnetic field generation apparatus provided by the invention has a simple structure and can implement the adjustment in the direction of magnetic lines of force by changing the current magnitude. Since the iron core in each coil is continuous, the annular magnetic pole is formed after the single coil is electrified and has a continuous magnetic field in an annular direction, the magnetorheological fluid is uniformly distributed along the annular direction, and the rotation direction of a workpiece is vertical to the direction of the magnetic lines of force, so that a shear force applied to the surface of the workpiece is large.

The apparatus of the invention is used for a magnetorheological fluid to process a multi-degree of freedom movement workpiece, and with a single clamp, is capable of simultaneously performing polishing processing on the outer surface(s) of one or more workpieces, the outer surface(s) of which may be flat surfaces, cambered surfaces or complex curved surfaces. Through the try-out of the invention, it is demonstrated that the apparatus effectively solves the problem of it being difficult to finish complex shaped surfaces, reduces workpiece processing procedures, and effectively increases polishing efficiency.

A technical solution of the invention will be further illustrated in combination with accompanying drawings.

### BRIEF DESCRIPTION OF THE DRAWINGS

FIG. 1 is a structural schematic diagram of the invention.

FIG. 2 is a top view of FIG. 1

FIG. 3 is a schematic diagram of magnetic lines of force according to the invention.

FIG. 4 is a schematic diagram in which the invention is used to process a flat surface of a workpiece.

FIG. 5 is a schematic diagram in which the invention is used to process a curved surface of a workpiece.

### DETAILED DESCRIPTION OF THE PREFERRED EMBODIMENTS

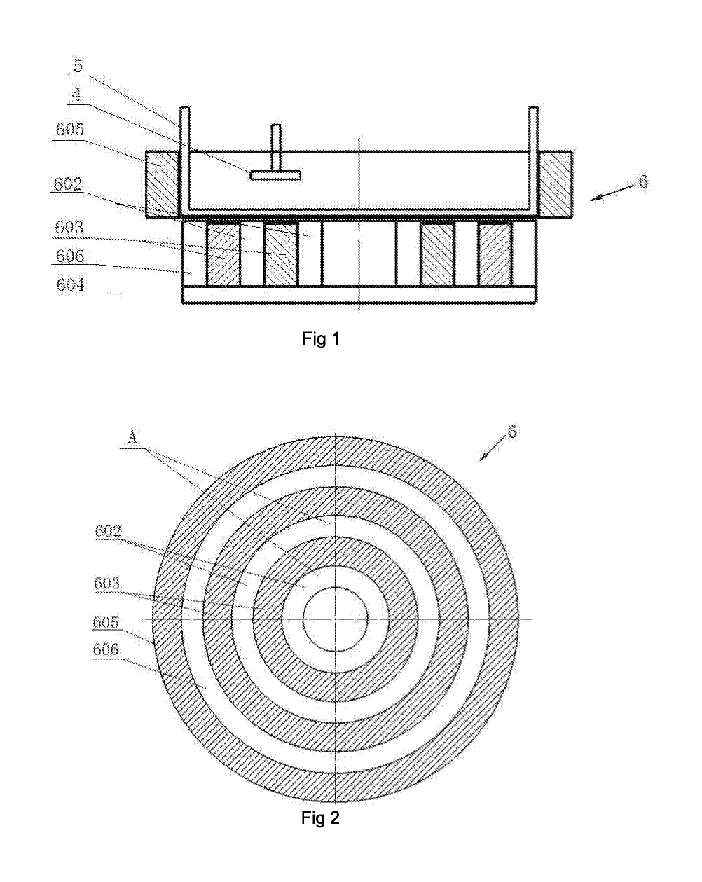

With reference to FIG. 1 to FIG. 3, a magnetic field generation apparatus 6 provided by the invention is arranged below a cylindrical polishing fluid tank 5, and comprises two (or more) annular magnetic poles arranged in concentric circles, wherein the polarities of two adjacent magnetic poles are opposing; every two annular magnetic poles having opposing polarities form one electromagnetic pole set A; each annular magnetic pole comprises an annular magnetic core 602, and a magnetic core coil 603 wound on the outer surface of the annular magnetic core 602, with the annular magnetic core 602 and the magnetic core coil 603 fixed on a base plate 604; a protective ring 606 is arranged outside the outermost annular magnetic pole; meanwhile, an outer coil 605 is arranged on the outer periphery of the polishing fluid tank 5; and a lower plane of the outer coil 605 is flush with upper planes of the annular magnetic poles.

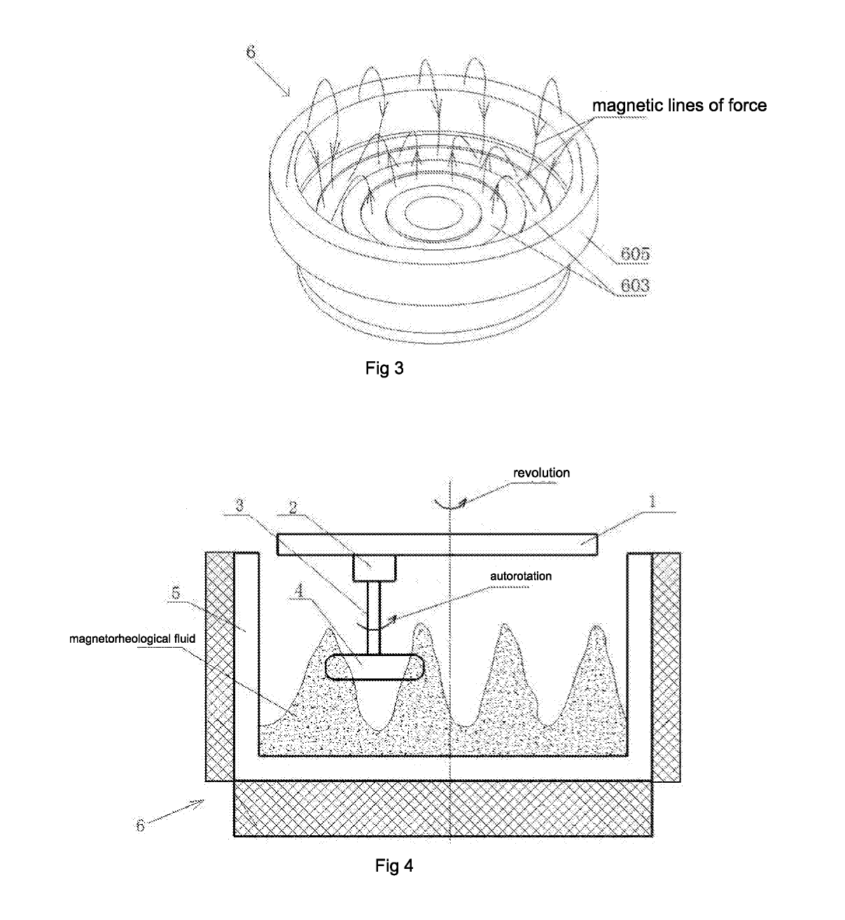

The magnetic core coils 603 have an electrification direction opposite to that of the outer coil 605, so that two magnetic poles having opposing polarities can be formed after electrification and a gradient magnetic field is produced between the two coils. After the outer coil 605 is electrified, the magnetic induction intensity B of the magnetic coils 603 undergoes vector superposing, therefore, the direction of the magnetic lines of force of the magnetic poles can be adjusted by changing the current of the outer coil 605 (refer to FIG. 3), and the requirements for different magnetic fields can be met when the flat surfaces and curved surfaces are processed. Naturally, the invention can likewise play a role of generating a magnetic field from the magnetorheological fluid without the arrangement of the outer coil 605, except that its effect is not as good as that when the outer coil 605 is arranged.

The magnetic field generation apparatus 6 of the invention can be used to finish a plurality of complex surfaces including flat surfaces, curved surfaces and the like for multi-degree of freedom movement workpieces. The application of the polishing device of the invention is as shown in FIG. 4, and the polishing device comprises a magnetorheological fluid tank 5 arranged on a rack, a large revolution disc 1 arranged above the magnetorheological fluid tank 5, a workpiece movement frame 2 arranged on the large revolution disc 1, and a workpiece 4 mounted on the workpiece movement frame 2 through a rotary shaft 3, and the magnetic field generation apparatus 6 of the invention is arranged at the bottom of the magnetorheological fluid tank 5.

After being electrified, the magnetic field generation apparatus generates a gradient magnetic field in the magnetorheological fluid tank 5, and the magnetorheological fluid forms a magnetic linkage, which is equivalent to individual small magnetic grinding heads, along the direction of magnetic lines of force under the action of the gradient magnetic field. When a workpiece driving mechanism drives the workpiece 4 to do a multi-degree of freedom movement in the magnetorheological fluid, the workpiece 4 and the magnetorheological fluid move relatively, the magnetorheological fluid applies a removing effect on the surface of the workpiece, thereby realizing polishing.

According to the magnetic circuit theorem, flux leakage may occur between two magnetic poles having opposing polarities, therefore, there is a gradient magnetic field produced at the place with flux leakage. Since the magnetic permeability μ, of a ferromagnetic material is very high, an iron core plays a role of concentrating magnetic induction fluxes into its inside. Magnetic induction lines produced by a current-carrying coil having no iron core are diffused in the whole space; and if the same coil is wound on a closed iron core, the magnitude of the magnetic flux is increased greatly, moreover, the magnetic induction lines are almost along the iron core. According to the Ampere circuital theorem,

$${NI}_{θ} = {∮}_{( L )} H \cdot dl = {\sum }_{i} {H}_{i} {I}_{i} = {\sum }_{i} \frac{{B}_{i} {I}_{i}}{{μ}_{0} {μ}_{i}} ,$$

wherein N and I₀ are the turns per coil and the electrified current respectively, Bᵢ is the magnetic induction intensity, lᵢ is the length of a magnetic circuit, μᵢ is the relative magnetic permeability, and μ₀ is the air magnetic permeability. Therefore, the magnitude of the magnetic induction intensity B can be changed by changing the electrified current of the coil and the length of the magnetic circuit.

In addition, the electrified lead may produce a magnetic field inside and around thereof, and according to the Biot-Savart Law,

$$B = {∮}_{L} dB = \frac{{μ}_{0}}{4 π} {∮}_{L} \frac{Idl \times \hat{r}}{{r}^{2}} ,$$

the magnetic induction intensity B is a vector surperposing result of the element magnetic induction intensity produced by each current elements Idl. Therefore, the magnetic induction intensity of a magnetorheological polishing magnetic field is the vector superposing result of the magnetic induction intensity \vec{B}ᵢ produced by each pole head, i.e. |\vec{B}=Σ\vec{B}ᵢ, and the direction of the magnetic induction intensity \vec{B} can be changed by changing the magnitude of the magnetic field current, thereby achieving the direction adjustability of the magnetic induction intensity \vec{B}.

According to the Biot-Savart Law, the magnetic induction intensity is a cross product of a current element and a radius vector and is an axial vector, therefore, the direction of the magnetic induction intensity can be changed by changing the radius vector. The radius vector can be changed by chamfering at each pole head, thereby possibly changing the direction of the magnetic induction intensity.

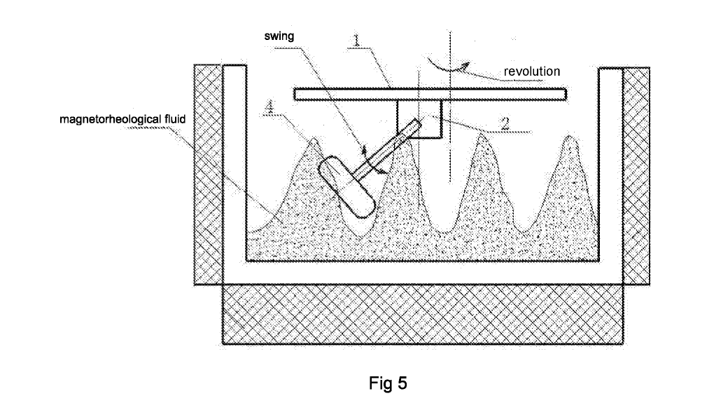

In this embodiment, the multi-degree of freedom movements of the workpiece can be realized by controlling different servo motors, any two of revolution, autorotation, and swing movements can be linked, one of the movements is also possible, and the three movements can also be linked at the same time. As shown in FIG. 4, when the revolution of the large revolution disc 1 and the autorotation of a driving rotary shaft 3 of the workpiece movement frame 2 are linked, the flat surface of the workpiece 4 can be processed; and as shown in FIG. 5, when the revolution of the large revolution disc 1 and the swing of the workpiece movement frame 2 (or the swing of the workpiece movement frame 2 and the autorotation of the rotary shaft 3) are linked, the curved surface of the workpiece 4 can be processed.

As can be seen from this, when the workpiece and the magnetorheological fluid undergo relative movement, the polishing of the flat face can be realized by means of the autorotation movement of the workpiece, the polishing of the curved surface or vertical surface can be realized by means of the swing movement of the workpiece, and the uniformity in polishing can be achieved by means of the revolution movement of a workpiece axis.

1. A magnetic field generation apparatus of a magnetorheological polishing device, characterized by comprising at least one electromagnetic pole set capable of producing a gradient magnetic field and consisting of two electromagnetic poles having opposing polarities, the electromagnetic poles forming the electromagnetic pole set using at least two annular magnetic poles arranged in concentric circles, wherein the polarities of two adjacent annular magnetic poles are opposing.

2. The magnetic field generation apparatus of the magnetorheological polishing device according to claim 1, characterized in that the annular magnetic pole comprises an annular magnetic core and a magnetic core coil wound on the outer surface of the annular magnetic core, with the annular magnetic core and the magnetic core coil fixed on a base plate.

3. The magnetic field generation apparatus of the magnetorheological polishing device according to claim 1, characterized in that the magnetic field generation apparatus is arranged below a cylindrical polishing fluid tank, an outer coil is arranged on the outer periphery of the polishing fluid tank, and a lower plane of the outer coil is flush with upper planes of the annular magnetic poles.
